(19) United States
(12) Patent Application Publication
(10) Pub. No.: US 2010/0319741 A1
(43) Pub. Date: Dec. 23, 2010

(54) Low Friction Leg Rest Attachable To An Orthopedic Walker

(76) Inventor: Uzi Ohayon, Eilat (IL)

Correspondence Address: The Law Office of Michael E. Kondoudis, 888 16th Street, N.W., Suite 800, Washington, DC, 20006, US

(21) Appl. No.: 12/486,243

(22) Filed: Jun. 17, 2009

(51) Int. Cl. A61H 3/00

(52) U.S. Cl. 135/67

(57) ABSTRACT

A leg rest attachable to an orthopedic walker having a frame. The leg rest comprises a surface and transporting elements attached to the lower side of the surface. The leg rest is operatively attached to the frame of the orthopedic walker such that the transporting elements contact the ground. The leg rest operatively supports a leg of a patient. Transporting elements are selected such as to allow the patient to easily move the orthopedic walker while supporting the leg on the leg rest.

### BACKGROUND

1. Technical Field

The present invention relates to the field of walking aids, and more particularly, to orthopedic walkers.

2. Discussion of Related Art

Patients with a lamed leg have great difficulties using common orthopedic walkers, which are constructed to support patients with two functioning legs.

### BRIEF SUMMARY

Embodiments of the present invention provide a leg rest attachable to an orthopedic walker having a frame. The leg rest comprises a surface with an upper side and a lower side; and at least one transporting element attached to the lower side of the surface. The leg rest is operatively attached to the frame of the orthopedic walker such that the at least one transporting element contacts the ground. The leg rest operatively supports a leg of a patient. The at least one transporting element is selected such as to allow the patient to easily move the orthopedic walker while supporting the leg on the leg rest.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIGS. 1A and 1B are illustrations of a low friction leg rest attached to an orthopedic walker, according to some embodiments of the invention;

FIG. 2 is a bottom view illustration of low friction leg rest attached to orthopedic walker, according to some embodiments of the invention; and

FIG. 3 is a high level schematic flowchart of a method of accommodating a walker for use by a patient with a debilitated leg, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

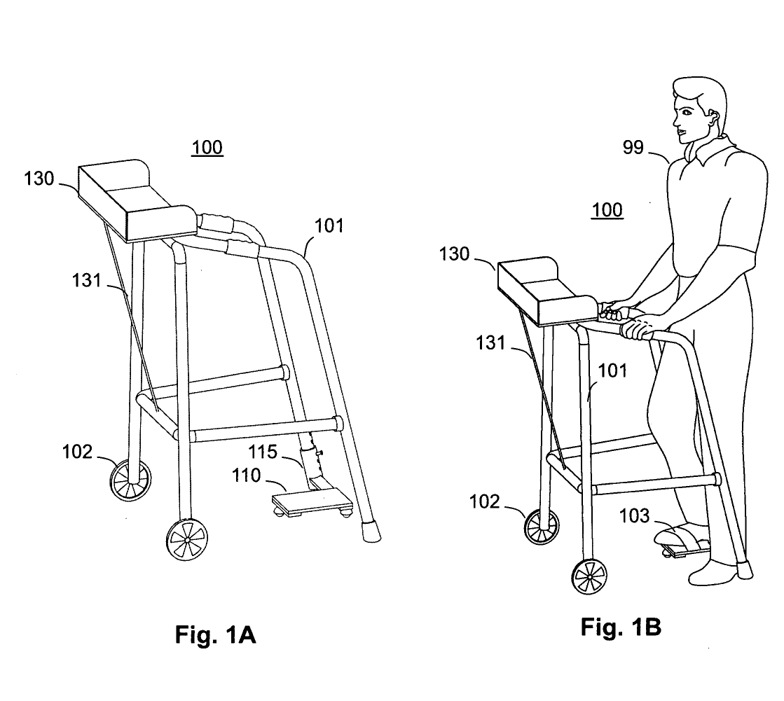

FIGS. 1A and 1B are illustrations of a low friction leg rest 110 attached to an orthopedic walker 100, according to some embodiments of the invention. Orthopedic walker 100 comprises a frame 101 (e.g. comprising a supporting structure, legs and wheels 102 on some of its legs) and leg rest 110 attached to frame 101, e.g. by an adjustable connector 115. Orthopedic walker 100 may comprise additional accessories such as a tray 130 supported by a rod 131 and attached to frame 101. Leg rest 110 may be adjustably attached to the frame of the orthopedic walker, and may be foldable such as to allow a patient 99 move the orthopedic walker without supporting the leg on leg rest 110. Leg rest 110 may be movably attached to frame 101 of orthopedic walker 100. The foot of patient 99 may be adaptably fastened by fastening means 103 to leg rest 110.

According to some embodiments of the invention, orthopedic walker 100 may further comprise a control unit arranged to controllably move leg rest 110.such as to treat the leg in a physiotherapeutic manner, for example encourage patient 99 to move the leg, support circulation and avoid necrosis.

According to some embodiments of the invention, orthopedic walker 100 may be further arranged to exhibit various movability modes, allowing easier or harder movement of orthopedic walker 100, or suit different terrain. A specific movability mode may be selected according to patient preferences in relation patient 99's feeling and environment. A specific movability mode may be selected according to physician's instructions relating to the medical situation of patient 99. A specific movability mode may be selected responsive to the pressure applied by the leg. Movability modes may be arranged to prohibit movement of orthopedic walker 100 when the pressure is insufficient to avoid an instability risk.

According to some embodiments of the invention, orthopedic walker 100 may further comprise an indicator arranged to indicate incorrect placing of the leg upon leg rest 110. The indicator may be mechanical, optical or electric. Orthopedic walker 100 may arranged to preclude movement in cases of incorrect placing of the leg upon leg rest 110.

According to some embodiments of the invention, orthopedic walker 100 may be any walker on the market, or a specially produced walker with extended functionalities. In the first case leg rest 110 is attachable to orthopedic walker 100, in the second case leg rest 110 may be an integral part of orthopedic walker 100 or be operatively attachable.

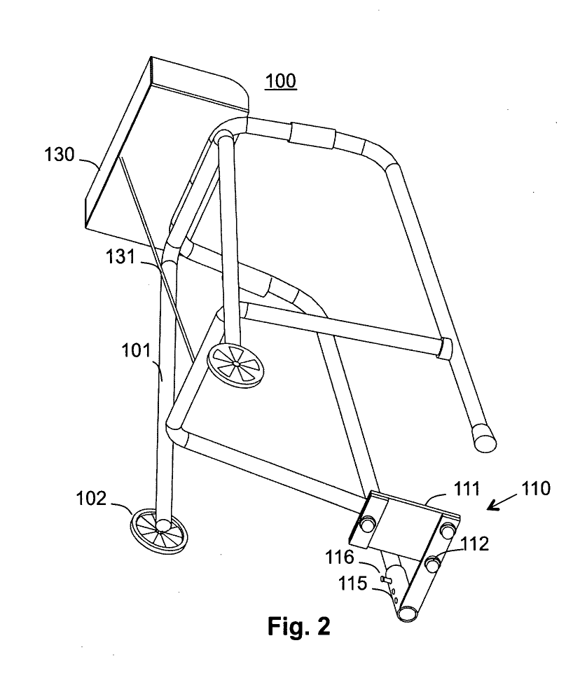

FIG. 2 is a bottom view illustration of low friction leg rest 110 attached to orthopedic walker 100, according to some embodiments of the invention. Leg rest 110 comprises a surface 111 with an upper side and a lower side and transporting elements 112, such as wheels or bearings attached to the lower side of the surface. Transporting elements 112 may comprise wheels or bearings of different sizes suiting for different and changing terrain.

In operation, leg rest 110 is attached to frame 101 of orthopedic walker 100 such that transporting elements 112 contact the ground and leg rest 110 is adjusted (e.g. by fixating adjustable connector 115 with a screw 116) to support a leg of a patient. Transporting elements 112 are selected to allow patient 99 to easily move orthopedic walker 100 while supporting the leg on leg rest 110.

According to some embodiments of the invention, adjustable connector 115 may be arranged to allow any of the following: adjustably attaching leg rest 110 to frame 101 of orthopedic walker 100; movably leg rest 110 to frame 101 of orthopedic walker 100; and folding leg rest 110 such as to allow patient 99 move orthopedic walker 100 without supporting the leg on leg rest 110. Leg rest 110 may further comprise a control unit arranged to controllably move leg rest 110 such as to treat the leg in a physiotherapeutic manner. The controllable movements may be selected as to imitate natural movements of the leg. Adjustable connector 115 may be arranged to allow fixating leg rest 110 at various angles (horizontally, vertically and tilt). Adjustable connector 115 may comprise a spring for allowing patient 99 practice changing the weight or pressure applied by the leg on leg rest 110.

According to some embodiments of the invention, leg rest 110 may be arranged to exhibit various movability modes, selectable in relation to at least one of: patient preferences, physician's instructions, a medical state of patient 99, and a pressure applied by the leg.

According to some embodiments of the invention, leg rest 110 may further comprise an indicator arranged to indicate incorrect placing of the leg upon leg rest 110. The indicator may comprise an alarm, or a display indicated a correct placing. Leg rest 110 may further comprise a fastener arranged to fixate the leg onto leg rest 110.

According to some embodiments of the invention, leg rest 110 may be attached to orthopedic walker 100 at various locations and heights on frame 101, including left and right attachment to frame 101.

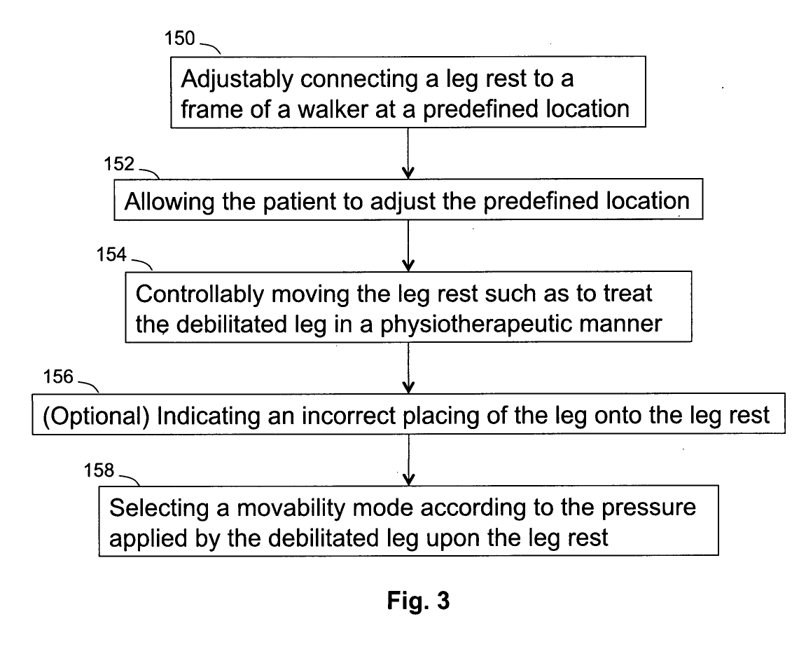

FIG. 3 is a high level schematic flowchart of a method of accommodating a walker for use by a patient with a debilitated leg, according to some embodiments of the invention. The walker comprises a frame. The method comprises adjustably connecting a leg rest to the frame at a predefined location (stage 150). The leg rest comprises a surface with an upper side and a lower side with at least one transporting element attached to the lower side of the surface. The leg rest may be attached to the frame (stage 150) by various means, for example by drilling holes into the frame and connecting an attachment to the leg rest using a bolt. The leg rest may be attached to the frame (stage 150) mechanically or otherwise, and the attachment may be adjustable to characteristics of the walker and of the patient.

The predefined location is selected such as to allow placing the debilitated leg upon the leg rest. The method may further comprise allowing the patient to adjust the predefined location (stage 152). The patient is allowed to rest the debilitated leg on the leg rest while pushing the walker.

According to some embodiments of the invention, the method may further comprise controllably moving the leg rest such as to treat the debilitated leg in a physiotherapeutic manner (stage 154). For example, the leg rest may be gradually tilted forward and backward such that the movement evokes blood circulation and joint movement contributing to the healing process of the debilitated leg. The leg rest may be connected to a controller allowing a user to choose from various operation modes of moving the leg rest.

According to some embodiments of the invention, the method may further comprise indicating an incorrect placing of the leg onto the leg rest (stage 156). The indication may comprise visual or audio signals, as well as mechanical prohibition of movement of the walker in case the debilitated leg is not well supported by the leg rest. The indication may be generated via optical, mechanical or electrical sensors, or may be integrated structurally in the leg rest (for example, the transporting elements may be configures to be movable only upon sufficient pressure application.

According to some embodiments of the invention, the transporting element/s may comprise various movability modes such as easy (low friction) or hard (high friction). The method may further comprise selecting a movability mode according to the pressure applied by the debilitated leg upon the leg rest (stage 158). Alternatively or complementary, a patient or a physician may select an appropriate movability mode according to the state of the debilitated leg.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. An orthopedic walker comprising:
a frame; and
a foot rest attached to the frame and comprising:
a surface with an upper side and a lower side; and
at least one transporting element attached to the lower side of the surface,
wherein the foot rest is operatively attached to the frame of the orthopedic walker such that the at least one transporting element contacts the ground,
wherein the foot rest operatively supports a foot of a patient, and
wherein the at least one transporting element enables the patient to easily move the orthopedic walker while supporting the foot on the foot rest.

2. The orthopedic walker of claim 1, wherein the foot rest is adjustably attached to the frame of the orthopedic walker.

3. The orthopedic walker of claim 1, further comprising a tray.

4.-6. (canceled)

7. The orthopedic walker of claim 1, wherein the foot rest is foldable such as to allow the patient move the orthopedic walker without supporting the foot on the foot rest.

8. A foot rest attachable to an orthopedic walker having a frame, the foot rest comprising:
a surface with an upper side and a lower side; and
at least one transporting element attached to the lower side of the surface,
wherein the foot rest is operatively attached to the frame of the orthopedic walker such that the at least one transporting element contacts the ground,
wherein the foot rest operatively supports a foot of a patient, and
wherein the at least one transporting element enables the patient to easily move the orthopedic walker while supporting the foot on the foot rest.

9. The foot rest claim 8, further comprising an adjustable connector arranged to allow adjustably attaching the foot rest to the frame of the orthopedic walker.

10. (canceled)

11. The foot rest claim 8, further comprising an adjustable connector arranged to allow folding the foot rest such as to allow the patient move the orthopedic walker without supporting the foot on the foot rest.

12.-14. (canceled)

15. The foot rest of claim 8, further comprising a fastener arranged to fix the foot onto the foot rest.

16. The orthopedic walker of claim 1, wherein the at least one transporting element is a rolling transporting element.

17. The foot rest of claim 8, wherein the at least one transporting element is a rolling transporting element.

18. The orthopedic walker of claim 1, wherein the at least one transporting element is selected from wheel and bearing.

19. The foot rest of claim 8, wherein the at least one transporting element is selected from wheel and bearing.

20. The orthopedic walker of claim 1, wherein the at least one transporting element is a low friction transporting element, enabling the patient to easily move the orthopedic walker while supporting the foot on the foot rest.

21. The foot rest of claim 8, wherein the at least one transporting element is a low friction transporting element, enabling the patient to easily move the orthopedic walker while supporting the foot on the foot rest.
